(19) United States
(12) Patent Application Publication
(10) Pub. No.: US 2004/0189515 A1
(43) Pub. Date: Sep. 30, 2004

(54) Hybrid satellite based positioning system

(76) Inventor: Giovanni Vannucci, Red Bank, NJ (US)

Correspondence Address: Mitsubishi Electric Research Laboratories, Inc., Patent Department, 201 Broadway, Cambridge, MA, 02139, US

(21) Appl. No.: 10/403,715

(22) Filed: Mar. 31, 2003

(51) Int. Cl. H04B 7/185; G01S 1/24

(52) U.S. Cl. 342/357.01; 342/387

(57) ABSTRACT

A hybrid satellite positioning system determines the position of a mobile terminal. The system is hybrid in that it uses GPS satellites together with other satellites not meant for positioning to achieve a position fix. It is advantageous in urban areas, where it is difficult to see enough GPS satellites, but many direct broadcast (DBS) satellites signals are available. the DBS signals can be used in place of GPS signals to achieve a fix. The system includes a stationary server for time stamping an auxiliary radio signal received from an auxiliary radio source, such as DBS satellite, according to a GPS-derived time reference. A mobile terminal also receives the same auxiliary radio signal and time stamps it according to a mobile time reference. The mobile terminal is linked to the server through a wireless telecommunication link. Through the link, it obtains the time stamped auxiliary signal received by the server. The mobile terminal performs a correlation to determine a timing offset between the two versions of received auxiliary signal. Then, the position of the mobile terminal can be determined by combining that offset with observations of GPS signals.

### FIELD OF THE INVENTION

The invention relates generally to positioning systems, and more particularly to satellite based positioning systems.

### BACKGROUND OF THE INVENTION

A large number of applications use the global positioning systems (GPS) for navigating and obtaining positional information. Example applications include road, railroad, marine, and air transportation management, as well as emergency and security operation, and personal navigation. Typically, a GPS receiver needs to receive timing signals from at least four GPS satellites in order to achieve precise real-time positioning.

At many locations, the GPS receiver cannot receive enough GPS signals to determine a very precise position. For example, in an urban environment, tall buildings obstruct a substantial portion of the sky, creating what is known as the urban canyon. Consequently, when the GPS receiver is in an urban canyon, it is very frequently unable to detect the signals from enough favorably positioned GPS satellites at many locations for short periods of time. Therefore, urban navigation systems, which must be able to determine the position of a vehicle within meters or less at all times, cannot rely on GPS alone.

It is well known in the art how to combine the signals from one satellite positioning system with the signals from another satellite positioning system. For example, GPS signals can be combined with GLONASS signals to achieve a more accurate position fix. GLONASS is a Russian satellite positioning system. New systems under development increase the number of positioning satellites, e.g., the multi-purpose transportation satellite (MTSAT) system, the highly elliptical orbit satellite (HEO) system, and the geostationary satellite (GEO) system. However, it takes an enormous amount of time, money and effort to deploy satellite systems. Even with these new systems, complete coverage in an urban environment cannot be guaranteed.

Therefore, there is a need for an enhanced satellite based positioning system that operates accurately in urban environments, that does not entirely rely on GPS satellites, and that does not require additional satellite launching costs.

### SUMMARY OF THE INVENTION

The invention uses GPS and auxiliary radio signals for determining the position of a mobile terminal in an urban environment. The auxiliary radio signals come from sources of opportunity that may not be originally intended for position determination. For example, a signal from a direct broadcast satellite (DBS) can be used as an auxiliary signal. A stationary server assists the mobile terminal in the achievement of a position fix. The stationary server also receives the GPS and the auxiliary radio signals. The stationary server communicates with the mobile terminal over a wireless radio connection.

DBS satellites provide services that are unrelated to positioning, e.g., digital TV, HDTV and direct audio broadcast. However, the invention makes it possible to use a DBS radio signal as an auxiliary radio signal to greatly enhance the performance and accuracy of a GPS positioning receiver without making any modifications to the GPS and DBS transmitters. For example, the radio signal from the DBS satellite can be used when insufficient GPS signals are available.

The idea behind the invention is based on the fact that digital wireless coverage is available in most areas where positioning is desired, e.g., urban environments. Through a digital wireless service, such as a third generation (3G) wireless service, the stationary server conveys an assistance message to the mobile terminal. The assistance message contains information that allows the mobile terminal to use the DBS signal for positioning as if it were a GPS signal.

The invention also provides a method for self-calibration that allows the mobile terminal to achieve high accuracy without requiring difficult calibration measurement. The self-calibration method is feasible if, at least some of the time, enough GPS signals can be received to meet the position accuracy requirement, without requiring the use of auxiliary radio signals.

### BRIEF DESCRIPTION OF THE DRAWINGS

FIG. 1 is a block diagram of a hybrid satellite based mobile positioning system according to the invention;

FIG. 2 is a block diagram of an auxiliary stationary positioning server according to the invention;

FIG. 3 is a flow diagram of a method for time-stamping an auxiliary radio signal and generating an assistance message in a stationary server according to the invention;

FIG. 4 is a block diagram of a mobile terminal according to the invention;

FIG. 5 is a flow diagram of a method for time-stamping the auxiliary radio signal in a mobile terminal according to the invention;

FIG. 6 is a flow diagram of a method for determining the position of a mobile terminal according to the invention; and

FIG. 7 is a flow diagram of a method for determining the value of a calibration term according to the invention.

### DETAILED DESCRIPTION OF THE PREFERRED EMBODIMENT

Introduction

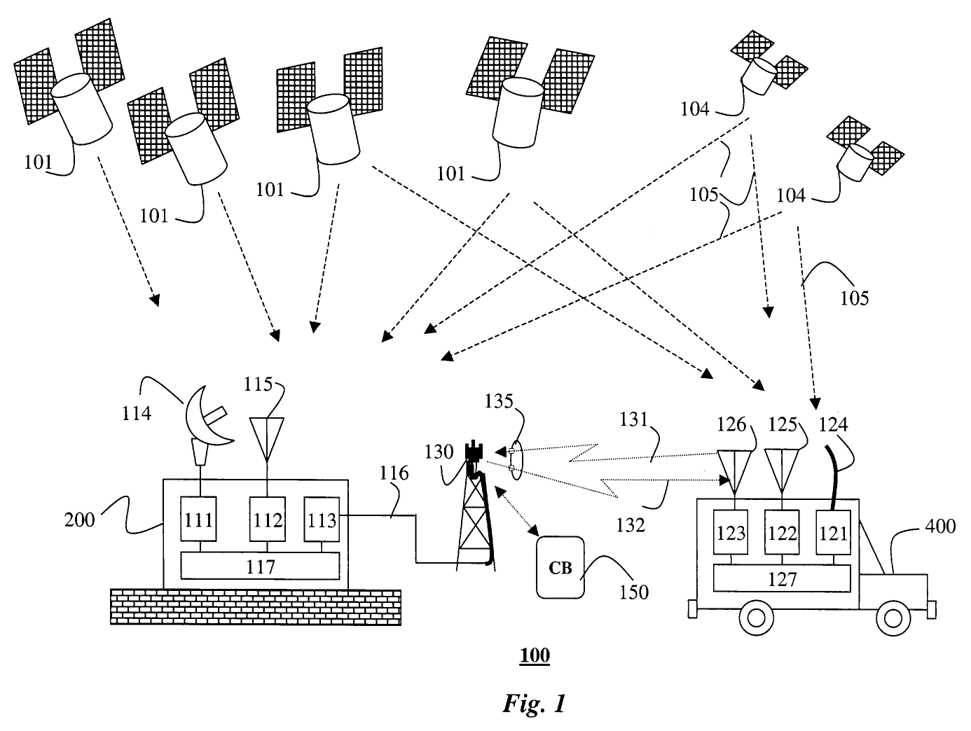

FIG. 1 shows a hybrid satellite based mobile positioning system 100 according to the invention. The system includes GPS satellites 101 and one or more auxiliary source 104 of auxiliary radio signals 105. It is a feature of this invention that the auxiliary radio signals 105 can be signals not specifically intended for position determination, and the auxiliary sources 104 can be sources of opportunity operated for purposes other than position determination. For example, the auxiliary sources can be digital broadcasting (DBS) satellites, and the auxiliary radio signals 105 can be the signals transmitted as part of normal operation of a DBS satellite. Other kinds of radio signal sources can be used in place of DBS satellites. However, DBS satellites are especially advantageous because of the high power level of the transmitted radio signal.

The purpose of the system 100 is to enable a mobile terminal 400 to determine its own position in an urban environment where GPS systems fail because the GPS signals are too weak, or a sufficient number of GPS satellites cannot be observed. It should be noted that other positioning satellite systems could be used instead of the GPS positioning system 101.

The system 100 enables the mobile terminal 400 to determine its own position from signals obtained from both the GPS satellites and the DBS satellite. Although a nominal location of the DBS satellite may be known, the DBS signals are not synchronized with the GPS satellites, are not designed for timing and positioning, and, generally, are not under the control of the satellite positioning system. For the purpose of the present invention, it is assumed that the auxiliary radio signals 105 contain no timing information, i.e., they are non-timed auxiliary radio signals.

In the urban environment, there are a number of factors that make it possible to implement the positioning system according to the invention with the required accuracy, and at a low cost.

Recently introduced digital and third generation (3G) wireless radio services, such as cellular telephony, allow mobile and stationary devices to communicate with each other via radio signals. Service coverage in urban areas is usually complete, at a reasonable cost, and the bit rate is sufficient to support high-speed data transfers.

In the urban environment, there are some locations where four or more GPS satellites are visible, for example, on rooftops, at major intersections, on wide avenues, and in open areas such as parks and parking lots. Therefore, a mobile GPS receiver will sometimes be at a location where it can receive at least four GPS timing signals. When that happens, the GPS receiver can determine precise positions without any help from any other satellites. This is beneficial for calibration, as described below.

Urban environments also have access to one or more DBS satellite broadcast signals. These signals are typically relatively strong so that small, low-cost receivers can receive the DBS signals. In combination, these factors, make it possible to implement the mobile positioning system according to the invention.

In this description of the preferred embodiment, the invention is described in terms of the GPS satellite positioning system. However, the invention is equally applicable to any other satellite based positioning system such as, for example, the Russian GLONASS system or the proposed European GALILEO system. Indeed, the techniques described here do not require that the positioning system be satellite based.

For example, a wireless telephone system based on code division multiple access (CDMA) can provide an estimate of the position of a CDMA wireless terminal by means of radio measurements using well-known techniques. Furthermore, the CDMA system can also provide an accurate estimate of time at the location of the wireless terminal. These estimates can be used in conjunction with the present invention to achieve an improved or enhanced position fix by combining the signal from a DBS satellite with the CDMA radio signal. In this case, the DBS source 104 is used to substitute for a CDMA source in areas where not enough CDMA sources are available for a successful position fix.

System Structure

According to the invention, the mobile terminal 400 is able to utilize the auxiliary signals 105 for positioning using an assistance message obtained through a telecommunication link. Accordingly, the system 100 includes an auxiliary subsystem to provide the necessary assistance to the mobile terminal 400. The auxiliary subsystem comprises: at least one stationary server 200; one or more optional calibration terminals 150; and telecommunication links linking together the stationary server 200, the calibration terminals 150, and the mobile terminal 400. In the preferred embodiment, the telecommunication link to the mobile terminal 400 is a wireless link.

At the stationary positioning server 200, there is a reference DBS receiver 111, a reference GPS receiver 112, and a digital link 113 to a digital network 116. For example, the digital network 116 might be a wide area network such as the Internet. The DBS receiver 111 is equipped with a high-gain, directional antenna 114. The antenna 115 of the GPS receiver 112 is positioned so as to receive enough GPS signals at all times to determine a stationary time reference. The DBS receiver 111, the GPS receiver 112 and the digital link 113 are interconnected through a stationary signal processor 117.

The mobile terminal 400, e.g., a terminal in a vehicle, includes a mobile DBS receiver 121, a mobile GPS receiver 122, and a mobile wireless transceiver 123. The antennas 125, 126 for the GPS receiver and the mobile wireless transceiver are conventional antennas as generally used for such receivers. In contrast, the antenna 124 for the DBS receiver is not a high-gain antenna, as generally used for such receivers, rather, it is a simple small-size, low-cost omni-directional antenna.

The mobile wireless transceiver 123 provides a digital connection to the stationary server 200, for example, through the Internet, via a bi-directional wireless connection 135 to a wireless base station 130 operated by a digital wireless service provider. The DBS receiver 121, the GPS receiver 122, and the wireless transceiver 123 are interconnected through a mobile signal processor 127.

In an alternative embodiment, the mobile terminal 400 can be connected to the Internet directly through a wired connection. For example, the mobile terminal can be a laptop computer, which, though directly connected to the Internet, does not know its own position.

In an alternative embodiment, described in greater detail below, the mobile wireless transceiver can be replaced by a mobile wireless receiver that is not adapted to transmit. In such an embodiment, the bi-directional wireless connection 135 is replaced by a uni-directional or broadcast wireless connection or service.

System Operation

When the mobile terminal 400 is unable to receive at least four GPS timing signals, as shown in FIG. 1, a request 131 for an “assistance message” is made to the stationary server 200 using the wireless transceiver. The assistance message 132 generated by the stationary server 200, in response to the request, provides the necessary information to enable the mobile DBS receiver 122 to detect a signal from the DBS satellite 104, even if the received signals are very weak. The message 132 also includes ephemeris data of the DBS satellite 104. Including ephemeris data is equivalent to specifying the position of the satellites in the sky. These data are used to determine a position fix from the DBS signals.

The stationary server 200 obtains the necessary data to generate the assistance message 132 from the reference DBS and GPS receivers 112 whose antennas have full view of enough GPS satellites, and any necessary DBS satellites.

The present system is in contrast with differential GPS (DGPS). The goal of DGPS is to improve accuracy by correcting measurement errors, whereas the hybrid system also uses signals from non-GPS satellites in place of GPS signals.

In the alternative embodiment where the mobile wireless transceiver is replaced by a mobile wireless receiver and the bi-directional wireless connection 135 is replaced by a uni-directional or broadcast wireless connection or service. The stationary server 200 generates assistance messages 132 without receiving a request 131. For example, the stationary server 200 can generate assistance messages 132 at regular time intervals.

Time-Stamping DBS Signals

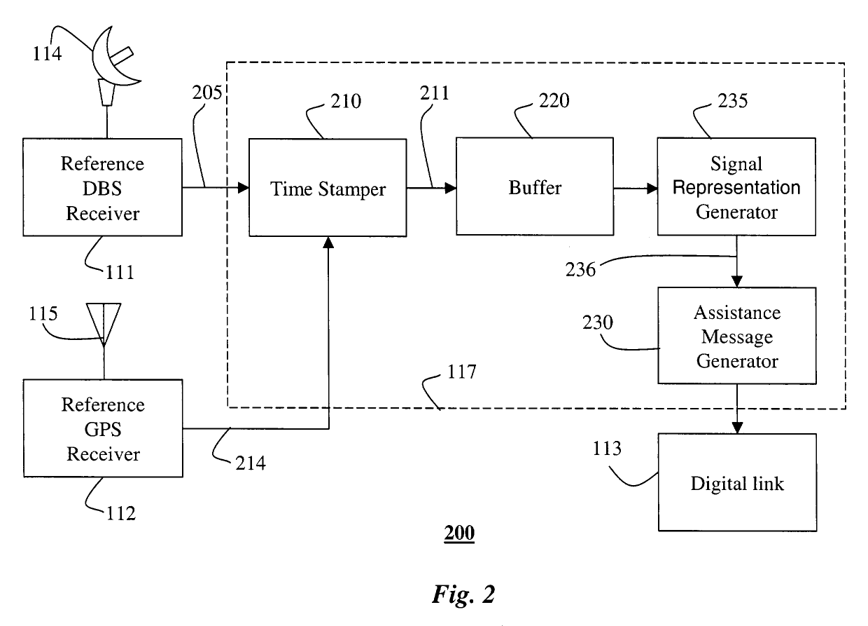

FIG. 2 shows details of the positioning server 200, in particular, the signal processor 117. The reference DBS receiver 111 generates a received DBS auxiliary radio signal 205, which is fed into a time stamper 210. The reference GPS receiver 112 generates a stationary GPS time reference 214, which is also fed into the time stamper 210. The time stamper 210 generates a time stamped stationary auxiliary signal 211, which is stored into a buffer 220.

When the stationary server 200 receives a request 131 for assistance, a signal representation generator 235 extracts information from the buffer 220 to generate a representation 236 of a portion of the stored auxiliary signal. Then, an assistance message generator 230 generates an assistance message, which includes the signal representation 236. The assistance message is subsequently fed into the digital link 113 for transmission to the mobile terminal 400.

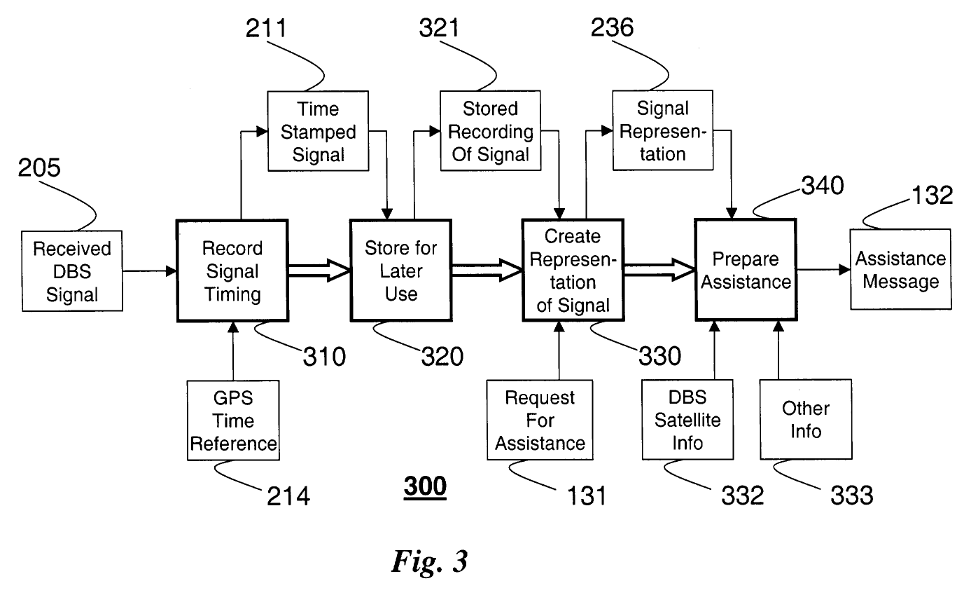

FIG. 3 shows details of a method 300 for time stamping the auxiliary radio signal 105 in the stationary server 200 and generating the assistance message. Because the high-gain antenna 114 provides good sensitivity with low interference, the reference DBS receiver 111 receives a “clean” DBS signal 205. At the same time, the reference GPS receiver 112 provides an accurate stationary time reference 214 to time stamp 310 the DBS signal 205. A time-stamped version 211 of the received DBS signal is stored 320 in a buffer 220 as a stationary time stamped auxiliary signal 321 for later use. The time stamped signal 211 is simply a recording of the received auxiliary signal where the exact timing of the received signal, as defined by the reference GPS receiver 112, is recorded together with the auxiliary signal 105.

The time stamp is based on the time when the DBS signal arrives at the time stamper 210 and on the time reference 214 provided by the GPS receiver 112. It is desired that the time stamp reflect the time when the DBS signal arrived at the antenna 114. This can be accomplished by the time stamper 210 if the delays introduced by the receivers 111 and 112 are known. The time stamper 210 can correct the time stamp to remove the error introduced by the receiver delays. For redundancy and better performance, the stationary server 200 can collect data from multiple satellite receivers at different locations, and about multiple satellites.

Because no processing, e.g., demodulation and waveform reconstruction, is performed on the DBS signal, other than the time stamping, the time stamped signal 211 can be stored in the buffer 220 as a digital recording of an analog waveform as it is received. In an alternative embodiment, the reference receiver 111 can demodulate the received signal and then reconstruct it. However, the delay associated with demodulation and reconstruction becomes an important component of the delay introduced by the receiver 111. As already observed, this delay must be know precisely, in order to ensure that it can be compensated for by the time stamper 210.

The assistance message 132 is generated 340 by an assistance message generator 230. The assistance message generator obtains the stationary time stamped signal representation 236 from the signal representation generator 235. The signal representation generator responds to a request 131 for assistance by processing 330 the stored auxiliary signal 321 as needed to convert it into a suitable representation of the received auxiliary signal 205. For example, it can resample the signal in order to reduce the number of bits required to represent it, or it can filter the signal to achieve desired correlation properties, or it can quantize the signal to an appropriate resolution, or it can perform any combination of these and other signal conditioning operations. In general, the signal representation is a model of the received auxiliary signal 205 suitable for computing a correlation. In the preferred embodiment, an efficient representation is achieved when the auxiliary radio signal is undersampled, compared to the Nyquist sampling rate, and when each sample is quantized to only one bit.

The assistance message 132 includes the signal representation 236, and it also includes ephemeris information 332 about the orbit of the DBS satellite. The assistance message also includes other information 333 that reflects the exact position of the stationary server 200, so that the time stamps can be related to the time of transmission of the auxiliary radio signal by the DBS satellite. It is well known in the art how to obtain satellite ephemeris data, how to determine the exact position of the reference receiver and how to convert the time stamp information as needed. The assistance message can also include additional types of information of use to the mobile terminal, such as, for example, data on the GPS system, geographic information, data on nearby services and landmarks, and any other information that facilitates position determination or the provision of location-based services (LBS).

The assistance message is conveyed to the mobile terminal 400 through the digital link 113. In an alternative embodiment, the message can include information that is derived from, and therefore equivalent to, the information described herein. For example, instead of satellite ephemeris and the position of the reference receiver, the message can include nominal parameters of the signal wavefront, such as the propagation vector referenced to a nominal, pre-determined position.

The assistance message generated by the stationary server 200 can be transmitted in broadcast or customized mode. In broadcast mode, the stationary server 200 transmits assistance messages 132 at regular intervals, and any mobile terminal that that needs assistance can monitor the broadcast channel. In customized mode, the stationary server sends the customized assistance message only in response to the request 131. Alternatively, the assistance message generator 230 can make assistance information available in a shared database. For example, the shared database can be a web site. A mobile terminal that needs assistance can access the web site and download the needed assistance message.

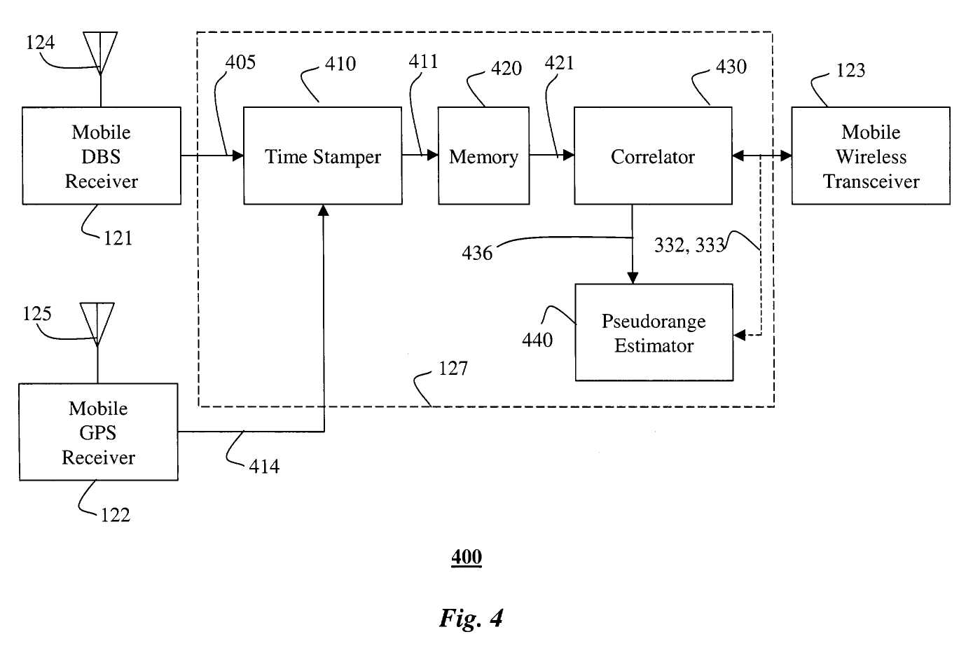

FIG. 4 shows details of the mobile terminal 400, in particular, the signal processor 127. The mobile DBS receiver 121 generates a received DBS auxiliary radio signal 405, which is fed into a time stamper 410. The mobile GPS receiver 122 generates a mobile GPS time reference 414 which is also fed into the time stamper 410. The time stamper 410 generates a time stamped mobile auxiliary signal 411 which can be stored into a memory 420.

To perform a hybrid positioning fix according to this invention, the mobile terminal stores a portion of time stamped signal 411 into the memory 420. At or near the same time, the mobile terminal 400 either monitors the above described broadcast channel for the assistance message, or, in custom mode, sends a request 131 for assistance to the stationary server 200. At a later time, the mobile terminal 400 receives an assistance message 132 through the mobile wireless transceiver 123. The received assistance message 132 contains a signal representation 236 suitable for computing a correlation. The correlator 430 extracts a stored time stamped signal 421 from the memory 420 and computes a correlation 436 with the signal representation 236. The pseudorange estimator 440 receives the correlation 436 and generates an estimate of a pseudorange of a DBS satellite. Optionally, the pseudorange estimator 440 can use ephemeris information 332 and other information 333 to generate an improved pseudorange estimate.

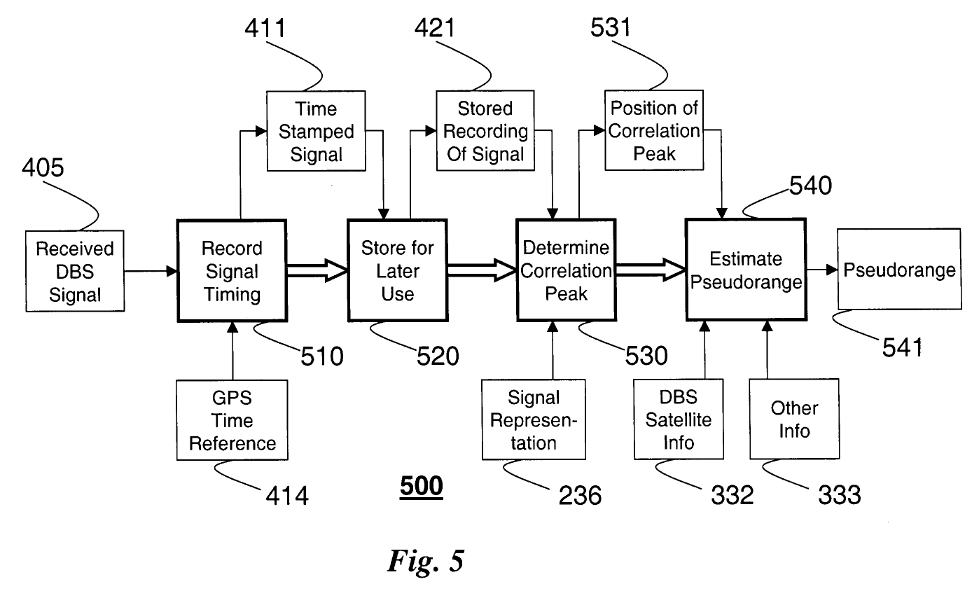

FIG. 5 shows a method 500 for time stamping the auxiliary radio signal 105 in the mobile terminal 400. Some steps are similar to those used in the stationary server 200. However, because the DBS antenna 124 is not a high-gain antenna, the received DBS signal 405 is very noisy. Furthermore, because the GPS receiver in the mobile terminal may not receive enough GPS signals, the mobile time reference 414 may be inaccurate. Nonetheless, this mobile time reference 414 is used to time stamp 510 the noisy received DBS signal 405. Similarly to the stationary terminal 200, the time stamped signal 411 is stored 520 into a memory 420 for later use.

Through the mobile wireless transceiver 123, the assistance message is obtained from the stationary server 200. As stated above, the message can also be received by other means. The message contains the signal representation 236, which was obtained from a clean version of the DBS signal time stamped with an accurate time reference. The correlator 430 determines a correlation of the clean signal representation 236 with the noisy stored signal 421.

The correlation exhibits a peak at a point where the clean signal matches the noisy signal. Determining 530 the exact position of the peak 531 reflects the difference between the timing of the clean signal and the timing of the noisy signal. The timing of the clean signal is derived from the accurate time stamping 310 of the auxiliary radio signal 105 as detected by the stationary server 200 at a known position. By contrast, the timing of the noisy signal is derived from the time stamping 510 of the same auxiliary radio signal 105 but as detected by the mobile terminal 400 at an unknown position. The difference between the two timings reflects the position of the mobile terminal.

The position of the correlation peak 531 is combined with the position of the satellite 104 to yield an estimate of the distance, or range, from the mobile terminal to the DBS satellite. Because the time stamping available in the mobile GPS receiver 400 may be inaccurate, the range estimate is referred to as ‘pseudorange’ 541. A pseudorange estimator 440 determines an estimate of the pseudorange of the satellite 104 based on the output of the correlator 430. The pseudorange estimator can, optionally, obtain ephemeris information 332 and other information 333 about the satellite 104 from the assistance message 132 to assist in determining the pseudorange. Other means of obtaining equivalent information are well known in the art.

The concept of pseudorange is well known, and it is also well known how to compute an estimate of the position of a mobile terminal from observations of multiple pseudoranges. Generally, a GPS position fix is computed from pseudorange measurements for multiple GPS satellites. Depending on the details of the chosen computational technique, the number of pseudoranges or, equivalently, satellites required for a successful position fix may vary. Generally, three or four pseudoranges are required. According to the present invention, the pseudorange determined by the pseudorange estimator 440 for the DBS satellite can be used in place of one pseudorange for a GPS satellite for the purpose of achieving the necessary number of pseudoranges.

Hybrid Positioning Method

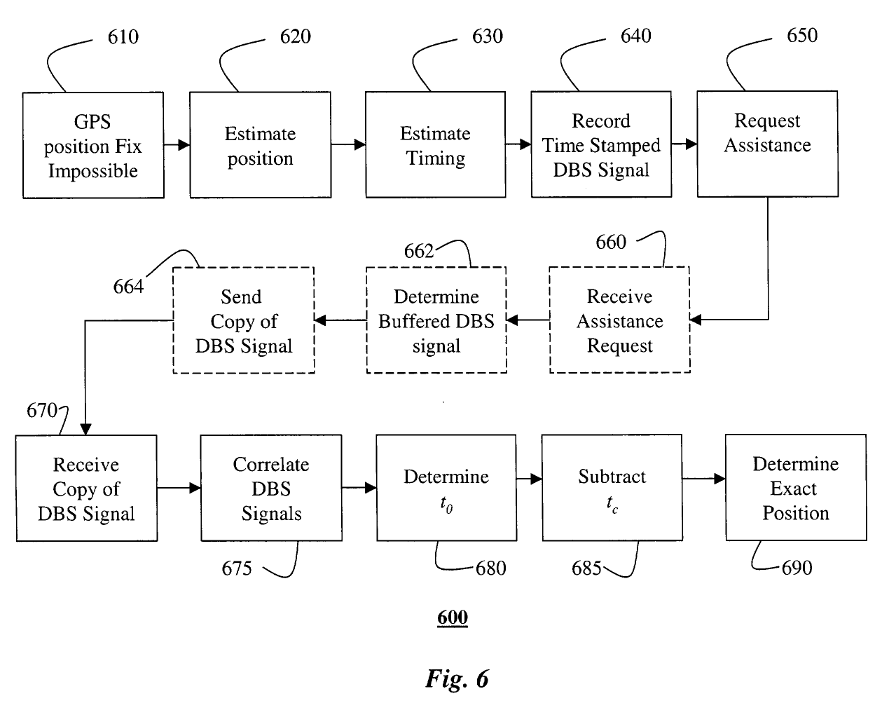

FIG. 6 shows the steps of a method 600 performed in the stationary server 200 and the mobile terminal 400 in order to obtain a position fix. In particular, steps 660-664 take place in the stationary server 200 and are shown with a dashed outline to distinguish them from the other steps, shown in solid lines, that take place in the mobile terminal 400.

First, the mobile terminal 400 determines 610 that it cannot detect enough GPS signals to do an accurate position fix with the GPS signals alone, for example, when the mobile terminal detects fewer than four GPS signals, or the dilution of precision is excessive for the available GPS geometry, or the signal from some GPS satellites is too weak, or the receiver detects excessive multipath distortion that cannot be corrected, or some other impairment occurs in the GPS signals.

In preparation for issuing the request 131 for the assistance message 132, the mobile terminal 400 estimates 620 its own position. It is not necessary for this estimate to be accurate. For example, the estimate can be within 1 km of the actual position. If nothing else is available, then the current position can be extrapolated from a last accurate position fix through ‘dead reckoning’. However, in most cases, the mobile terminal can use partial GPS information to make an approximate position fix. An estimate of the mobile terminal's position can also be obtained from the wireless service provider that manages the base station 130. Because the position of the base station is known to the wireless service provider, that position can be made available to the mobile terminal which can then use it as the estimate of its own position.

If at least one GPS signal with reasonable signal strength is received, then that signal can be used to estimate 630 GPS timing based on the estimated position. If the position error is about 1 km, as in the example above, then the timing error is about 3.3 microseconds. Alternatively, an estimate of GPS timing can be obtained from a radio signal received from the base station 130, or from digital information obtained through the digital wireless link. For example, time information can be obtained from an Internet time server. In the latter case, the timing error will generally be much larger than 3.3 microseconds.

At this point, the mobile terminal 400 can record 640 the time stamped DBS signal into the memory 420 as the stored time stamped signal 421. Because the antenna 124 is omni-directional, the recorded DBS signal is a combination of signals from all DBS satellites transmitting in the bandwidth of the mobile DBS receiver 121. Because the antenna 124 has low gain, the signal-to-noise ratio (SNR) is low, and the recorded DBS signal is mostly noise. However, it is well known how to determine a duration of signal to be recorded large enough that the correlator 430 can find a correlation peak 531 with the desired accuracy despite the low SNR.

Because of the uncertainties in position and timing discussed above, the actual DBS signal recorded into the memory 420 exhibits a time offset, compared to what would be recorded in the absence of uncertainties. In the preferred embodiment, the beginning of recording is anticipated and the end of recording is delayed enough to insure that, in spite of the offset, the desired portion of DBS signal is included in the memory 420.

Next, assistance is requested 650 from the stationary server 200. The request 131 includes the estimates of mobile terminal position and of the time when the DBS signal was recorded and buffered.

The stationary server 200 receives 660 the request. Because the stationary server has the exact position and timing information of itself, and the exact position in the sky of the DBS satellite 104, and has received, as part of the request, approximate position and timing information from the mobile terminal, the stationary server can determine 662 a portion of the DBS signal that is certain to be stored in the mobile terminal memory 420 despite all the uncertainties.

At this point, some time has elapsed since the mobile terminal 400 started recording the DBS signal. Therefore, the portion of DBS signal determined in 662 is already present in the buffer 220 as stored stationary time stamped auxiliary signal 321, and the stationary server sends 664 a representation 236 of that portion of the stored signal 321 to the mobile terminal 400 as part of the assistance message. In contrast with the noisy DBS signal 405 recorded by the mobile terminal 400, the exact time stamped signal representation 236 recorded by the stationary server is clean and, more important, not corrupted by signals received from other satellites or other sources. The assistance message 132 also includes the ephemeris of the DBS satellite, which are used by the mobile terminal for computing the satellite's pseudorange.

keep the assistance message 132 small, the duration of the portion of DBS signal included in the signal representation 236 sent in step 664 can be short, e.g., 1 ms. Also, it is not necessary that the signal representation 236 be sampled at the full Nyquist rate, which is at least two times the signal bandwidth. Even substantial undersampling will not adversely impact the quality of the correlation computed by the correlator 430. For a given number of bits available in the assistance message, an undersampled signal representation actually yields better performance. Similarly, the samples do not need several bits of sampling resolution. Single-bit samples, which are equivalent to just sampling the sign of the waveform, provide better performance than multi-bit samples.

The mobile terminal receives 670 the assistance message, and correlates 675 its stored time stamped signal 421 with the signal representation 236 included in the assistance message 132. The position of a correlation peak determines 680 a time t₀ of arrival of the DBS signal in the mobile terminal. The time t₀ reflects the pseudorange from the DBS satellite to the mobile terminal. It is well known in the art how to extract a pseudorange from a time of arrival of a satellite signal.

However, the time t₀ is corrupted by various sources of error, and cannot be used as is for exact position fixes. In order to correct for the various sources of error, the mobile terminal subtracts 685 a stored calibration term t_{c}. This yields a more exact time of arrival of the DBS signal. The time of arrival can now be used to obtain an accurate position 690 of the mobile terminal, even though an insufficient number of GPS signals are available. The method can be repeated for other DBS satellite signals.

Calibration Term

The calibration term t_{c} enables a more accurate position fix. The DBS signal is normally unsuitable for position determination in the mobile terminal 400. This is mainly due to three problems. The mobile terminal would need a large, high-gain antenna carefully aimed at the satellite to obtain a clean signal, which is not practical in a mobile terminal; the timing of the DBS signal is not known; and the position, trajectory and ephemeris, of the DBS satellite are not known with sufficient accuracy.

Typically, a DBS receiver needs a high-gain antenna because the DBS signals have a very high data rate, in the order of tens of MegaHertz. In contrast, GPS signals can be received with a very small, low-gain antenna because the data rate is only about 50 bits per seconds. Because of the lower data rate, the received “energy per bit” (E_{b}) is much higher for GPS signals, even though the received signal power is much lower than for the DBS signal.

A large, high-gain antenna collects more of the received signal. With DBS and, especially, communication satellites, the large antenna is needed to make E_{b} large enough to detect the high-bit-rate signal. Because the mobile DBS receiver 121 does not have to detect the underlying content of the DBS signal, a weaker and noisy signal can be received and correlated with an accurate representation of the signal to extract accurate timing information.

For example, if the assistance message includes 10,000 (10K) bits of information in the signal representation of the recorded DBS signal, then the SNR available to mobile terminal, when it performs the correlation, is increased by a factor of about 10K, or 40 dB. Consider that a typical DBS antenna has a gain of 20-30 dB, compared to the omni-directional antenna 124 of the mobile DBS receiver, the 10K-bit message compensates for the loss in antenna sensitivity with a substantial margin. Indeed, this extra margin improves the performance of the mobile positioning terminal. A message size of 10K bits is relatively modest for a 3G wireless connection as described above.

There are many sources of error that make the value of t₀ inaccurate. Another important source of error is the differential delay between the DBS and GPS receivers in both the stationary server and the mobile terminal. All of these sources of error change slowly over time, e.g., over a time scale of hours, or over position, e.g., over a distance scale of many kilometers.

The calibration term, t_{c} corrects for these errors as the signals are processed. The mobile terminal can determine the correct value of the calibration term t_{c} and keep the value up to date as part of normal operation. The following paragraphs describe a technique for determining and updating the value of t_{c} as part of the preferred embodiment of the invention.

Specifically, in a typical application, the mobile terminal will occasionally be at “good” locations where a sufficient number of GPS signals can be received to obtain accurate timing and position without the assistance of the stationary server 200. At those times, the mobile terminal 400 requests “assistance” from the stationary server 200, even though the mobile terminal does not need assistance. Then, the estimates in steps 620 and 630 are exact, and the time t₀ derived in-step 680 is not affected by discrepancies between estimated and actual position or between estimated and accurate time reference.

In the absence of estimation discrepancies, any residual error in the position t₀ of the correlation peak is caused by the combined effect of all other sources of error mentioned above. In other words, when the mobile terminal is at a good location, where the GPS signals alone are sufficient to obtain an accurate position, the observed offset in the correlation peak, is exactly equal to the value of the calibration term t_{c} for the current position and time. Because the value t_{c} varies slowly over time and distance, the mobile terminal can store the observed value of the offset for use later as the calibration term t_{c} .

When, at a later time, the mobile terminal is at a “bad” location, the stored value of the calibration term t_{c} provides an accurate correction for all the sources of error whose contribution has not changed substantially over time.

The calibration term can compensate for inaccurate knowledge of the satellite's position in the sky. For example, if the actual position of the satellite is different from the position known to the stationary server 200 by 1 milliradian, and the calibration term t_{c} was determined ten minutes earlier, when the mobile terminal was at the good location about 1 km away from the current position, then the discrepancy of 1 mrad between the actual position and the estimated position of the satellite is essentially unchanged over such a short period of time. This discrepancy has a strong influence on the value of t_{c} due to the distance between the stationary server and the mobile terminal, which can be much larger than 1 km. However, the influence is much the same as it was ten minutes earlier when t_{c} was stored. There is only a small difference due to the 1 km distance between the position where the calibration term t_{c} was stored, and the current position. Over such a short distance, the 1 mrad error leads to an error of only about one meter, a value obtained by multiplying the 1 km distance by 1 mrad.

Thus, the “self calibration” according to the invention is accurate and enables an implementation of the mobile terminal 400 at reasonable cost, and without requiring expensive factory calibration of the mobile terminal.

Calibration Method

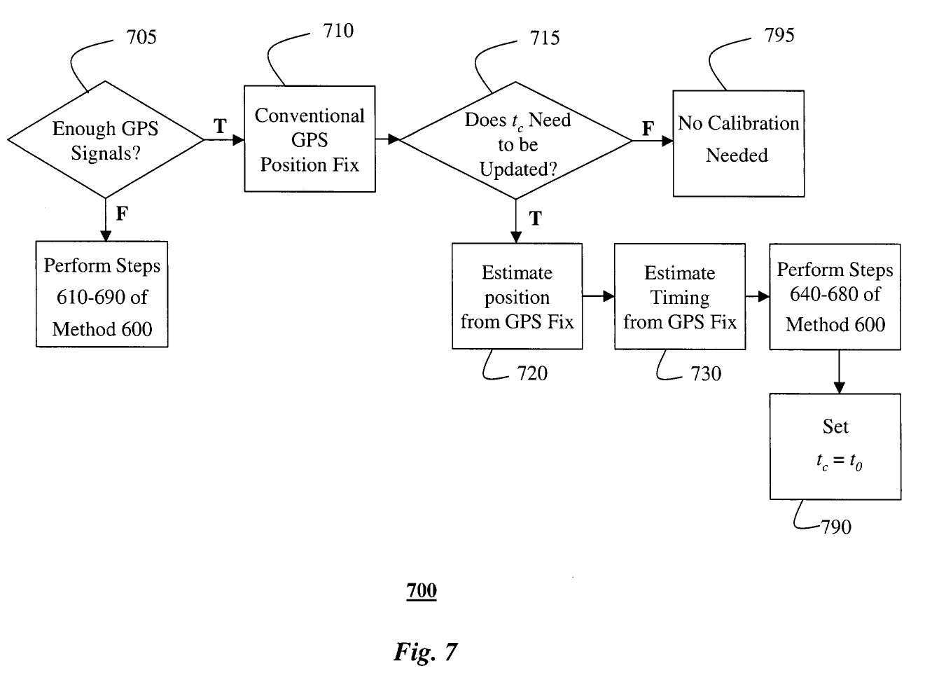

FIG. 7 illustrates the steps of a calibration method 700 used by the invention. When a position fix is needed, determine 705 whether enough GPS signals are available for determining a conventional, unassisted fix. If false, perform the steps 610-690 of the hybrid method 600. Otherwise, if true, the mobile terminal performs 710 a conventional, unassisted GPS fix. Then, determine 715 whether the calibration term, t_{c} , needs to be updated. If false, complete in step 795. Otherwise, if true, the mobile terminal uses the results of the GPS position fix to estimate 720 its own position, and to estimate 730 timing. Then, the mobile terminal obtains a value of t₀ through steps 640-680 of the method 600. Finally, the mobile terminal updates 790 the value of t_{c} using the observed value of tₒ.

It is well known in the art how to use multiple observed values of t₀ to obtain an enhanced estimate of t_{c} through techniques such as decaying averaging or Kalman filtering.

Determining the Ephemeris of the DBS Satellite

In the preferred embodiment, the stationary server 200 communicates to the mobile terminal 400 the ephemeris of the DBS satellite 104 or, equivalently, the stationary server communicates the position and motion of the satellite in the sky. The stationary server can obtain the necessary ephemeris information in a variety of ways. For example, the stationary server can use a high-gain antenna 114 with sufficient angular discrimination to accurately pinpoint the position of the satellite in the sky.

Alternatively, the stationary server can use an array of such antennas to achieve a higher degree of accuracy than is achievable with a single antenna. Alternatively, the stationary server can obtain accurate ephemeris information from the operator of the DBS satellite. Alternatively, the stationary server can obtain accurate ephemeris information from a satellite tracking service such as the one provided by the North American Aerospace Defense Command (NORAD). Alternatively the stationary server can use a network of terminals.

When the mobile terminal 400 performs the calibration method described above, the mobile terminal can optionally communicate to the stationary server 200 the value of t₀ obtained in step 680. As already noted, this value includes the effects of timing inaccuracies due to imperfections in the hardware, as well as inaccuracies due to errors in the satellite ephemeris. The effect of ephemeris errors is small, when comparing results obtained at positions that are short distance apart, e.g., when the distance between two positions is less than one kilometer.

However, if the stationary server 200 provides assistance to many mobile terminals 400 that are distributed over a wide area, the stationary server can compare values of the t₀ parameter obtained at positions that are very far from one another, e.g., the positions are more than 500 kilometers apart. In that case, the difference between values of the t₀ parameter is mostly due to the errors in the satellite ephemeris. In other words, the effect of ephemeris errors is greatly amplified when comparing values of t₀ observed at positions that are a large distance apart.

The stationary server 200 can combine the values of t₀ from a large number of mobile terminals to further reduce the error contribution due to terminal hardware through averaging of many values. It is well known in the art how to combine many such differential observations of time of occurrence to yield an accurate estimate of a satellite's ephemeris.

Calibration Terminals

In order to insure that an accurate knowledge of satellite ephemeris is always available, and to enhance operational reliability, the system can include one or more stationary servers 200 as well as one or more calibration terminals (CB) 150 used exclusively for calibration purposes, see FIG. 1.

The functionality of such specially designated calibration terminals is the same as that of the mobile terminal 400. However, the calibration terminals are deployed at pre-determined locations whose position is known accurately, and where the satellite signals can be received clearly. Furthermore, the calibration terminals are pre-calibrated prior to deployment, so that internal delays in the calibration terminals are known precisely. Thus, when a calibration terminal 150 reports a value of t₀ to the stationary server, the effects of internal terminal delays can be removed to yield a more accurate estimate of satellite ephemeris.

Alternative Embodiments

As shown in FIG. 6, various steps of signal processing and computation take place in a mobile terminal to obtain an accurate position fix. However, the steps can be performed in other devices. For example, the mobile terminal 400 can use the mobile wireless transceiver 123 to transmit the raw sampled waveform or waveforms from one or more received DBS or GPS signals to the stationary server 200 or to another device where all the computations are performed. The resulting position fix may, then, be obtained by the stationary server 200 or by another device, and can be transmitted optionally back to the mobile terminal, or used as needed to provide the end user with location-based services. Other ways of distributing the necessary steps among different devices are also possible.

DBS satellites are especially convenient as auxiliary radio sources for implementing the present invention because of the very strong signal they transmit. However, other types of satellites can also be used. It may be necessary increase the size of the memory 420 and the size of the signal representation 236, when weaker signals are received. Indeed, even non-satellite radio sources, such as TV broadcast stations are suitable. For example, a terrestrial transmitter of digital TV signals can be used instead of a DBS satellite in areas covered by such signals. Natural sources of radio signals such as, for example, pulsars or other astronomical radio sources can also be used.

The use of the mobile wireless transceiver 123 is especially convenient for a mobile terminal where tetherless operation is desired. However, the invention also works with a wired digital connection. Applications where this can be useful include mobile computing where a terminal connected to a LAN in some unknown location needs to determine its own position or needs accurate timing.

Alternatively, the invention may be applied to a tethered vehicle in, for example, an industrial park where the tether allows limited mobility and there is a need to determine the precise position of the tethered vehicle. Finally, the functional blocks of the stationary server 200 do not need to be co-located. For example, it is possible for the reference DBS receiver to be in one location, where it is convenient to have the high-gain antenna 114, while the buffer 220 and the assistance message generator 230 are in a different location, for example, as part of an Internet server, where it is convenient to have a connection to the digital link 113. However, it is important that the connection between the reference GPS receiver 112 and the time stamp 210 have a stable delay, so that the calibration method 700 functions properly.

FIG. 4 shows that the time stamper 410 uses the GPS-derived time reference 414 to time stamp the received signal 405. In an alternative embodiment, it is possible to use a different time reference not necessarily related to the GPS system. For example, it is possible to use a local, free running time reference. In such an embodiment, it is necessary to determine the timing of the received GPS signals relative to the same time reference. All these timings can be converted into a set of pseudoranges, for both DBS and GPS satellites, which include a common, unknown offset. It is well known how to process such a set of pseudoranges to achieve a successful position fix. The fix also provides an exact value for the unknown offset and, thereby, makes it possible to correct the local time reference such that it becomes a GPS time reference.

Effect of the Invention

Signals from DBS satellites can improve the accuracy of positioning because these signals have greater signal strength when compared with GPS signals. Even with a low-gain, omni-directional antenna, the mobile DBS receiver 121 has a substantial SNR margin for detecting the DBS satellite signal, thanks to the assistance message 132. This margin allows the mobile DBS receiver to detect a DBS signal even in situations where GPS signals are not detectable. Time stamped DBS signals are combined with GPS signals to obtain accurate position fixes.

Although the invention has been described by way of examples of preferred embodiments, it is to be understood that various other adaptations and modifications may be made within the spirit and scope of the invention. Therefore, it is the object of the appended claims to cover all such variations and modifications as come within the true spirit and scope of the invention.

I claim:

1. A method for determining a position of a mobile terminal, comprising:
time stamping an auxiliary radio signal received from an auxiliary radio source in a stationary server according to a stationary time reference received in the stationary server from a satellite positioning system to generate a stationary time stamped signal representation;
time stamping the auxiliary radio signal received from the auxiliary radio source in a mobile terminal according to a mobile time reference received in the mobile terminal from the satellite positioning system to generate a mobile time stamped signal representation;
transmitting the stationary time stamped signal representation to the mobile terminal;
correlating the stationary time stamped signal representation with the mobile time stamped signal representation to generate a timing estimate; and
determining a position of the mobile terminal from the timing estimate and position data of the auxiliary radio source and the stationary server.

2. The method of claim 1 wherein the auxiliary radio source is a digital broadcasting satellite.

3. The method of claim 1 wherein the auxiliary source is a terrestrial broadcasting system.

4. The method of claim 1 wherein the auxiliary source is a wireless telephone system based on code division multiple access.

5. The method of claim 1 wherein the stationary server includes a reference auxiliary radio signal receiver, a reference satellite positioning system receiver and a digital link to a digital network, and the mobile terminal includes a mobile auxiliary radio signal receiver, a mobile satellite positioning system receiver and a wireless link to the digital network.

6. The method of claim 5 wherein the reference satellite positioning system receiver is equipped with a high-gain, directional antenna, and the mobile satellite positioning receiver is equipped with an omni-directional antenna.

7. The method of claim 1 wherein the stationary time stamped signal representation is transmitted to the mobile terminal via a wireless link.

8. The method of claim 1 wherein the stationary time stamped signal representation is transmitted to the mobile terminal via a wide area network.

9. The method of claim 1 further comprising:
quantizing the auxiliary radio signal; and
storing each sample as one bit in the time stamped signal representations.

10. The method of claim 1 further comprising:
transmitting periodically the stationary time stamped signal representation to a plurality of mobile terminals in broadcast mode.

11. The method of claim 1 further comprising:
transmitting the stationary time stamped signal representation to the mobile terminals in response to a request by the mobile terminal.

12. The method of claim 1 further comprising:
storing the stationary time stamped signal representation in a shared database accessible by the mobile terminal.

13. The method of claim 1 further comprising:
estimating a position of the mobile terminal; and
transmitting the estimated position of the mobile terminal to the stationary server.

14. The method of claim 1 further comprising:
correcting the timing estimate by calibration term.

15. The method of claim 1 further comprising:
periodically computing the calibration term in the mobile terminal from at least four timing signals in the mobile time reference.

16. The method of claim 14 further comprising:
periodically computing the calibration term in a plurality of calibration terminals; and
transmitting the calibration term to the mobile terminal.

17. A method for determining a position of a mobile terminal, comprising:
receiving an auxiliary radio signal from an auxiliary radio signal source in a stationary server;
receiving a stationary time reference received in the stationary server from a satellite positioning system;
time stamping the auxiliary radio signal according to the mobile time reference to generate a stationary time stamped signal representation;
receiving the auxiliary radio signal from the auxiliary radio signal source in a mobile terminal;
receiving a mobile time reference received in the mobile terminal from the satellite positioning system;
time stamping the auxiliary radio signal according to the mobile time reference to generate a mobile time stamped signal representation;
transmitting the stationary time stamped signal representation to the mobile terminal;
correlating the stationary time stamped signal representation with the mobile time stamped signal representation to generate a timing estimate; and
determining a position of the mobile terminal from the timing estimate and position data of the auxiliary radio source and the stationary server.

18. A system for determining a position of a mobile terminal, comprising:
a stationary server configured to time stamp an auxiliary radio signal received from an auxiliary radio source according to a stationary time reference received from a satellite positioning system to generate a stationary time stamped signal representation;
a mobile terminal configured to time stamping the auxiliary radio signal according to a mobile time reference to generate a mobile time stamped signal representation, the mobile terminal further comprising;
means for receiving the stationary time stamped signal representation;
means for correlating the stationary time stamped signal representation with the mobile time stamped signal representation to generate a timing estimate; and
means for determining a position of the mobile terminal from the timing estimate and position data of the auxiliary radio source and the stationary server.

19. A method for determining a position of a mobile terminal, comprising:
correlating a stationary time stamped signal representation of an auxiliary radio signal according to a stationary time reference at a fixed location with a mobile time stamped signal representation of the auxiliary radio signal according to a mobile time reference to generate a timing estimate; and
determining a position of the mobile terminal from the timing estimate and position data of the auxiliary radio source and the fixed location.
